(19) United States
(12) Patent Application Publication
(10) Pub. No.: US 2013/0239654 A1
(43) Pub. Date: Sep. 19, 2013

(54) IMPACT TESTING DEVICE

(71) Applicant: LI-NA KONG, Shenzhen City (CN)

(72) Inventor: LI-NA KONG, Shenzhen City (CN)

(21) Appl. No.: 13/657,994

(22) Filed: Oct. 23, 2012

(30) Foreign Application Priority Data
Mar. 16, 2012 (CN) 201210070030.0

(51) Int. Cl. G01N 3/307

(52) U.S. Cl. 73/12.09

(57) ABSTRACT

An impact testing device used for testing impact resistance of electronic devices is provided. The impact testing device includes a main body, a pneumatic pump connecting to one end of the main body and communicating with the main body, a transmitting element connecting to the other end of the main body and communicating with the main body, and an impact head fastened on the transmitting element. The pneumatic pump renders the main body a pressure to drive the transmitting element and make the impact head move to hit the testing point of the electronic device.

### BACKGROUND

1. Technical Field

The present disclosure relates to an impact testing device for testing impact resistances of electronic devices.

2. Description of Related Art

Electronic devices, such as mobile phones, are usually impact tested to test their impact resistance. A typical method to test the electronic devices is manually operating an impact head to make the head fall down to hit the testing points of the electronic devices. The impact resistance of the electronic device is determined by the damaged condition of the electronic devices. However, the manual operation of the impact head commonly results in imprecise results. Furthermore, the impact head may hit the tester when it falls down or slides from the electronic devices (e.g., gravity operated).

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an exemplary embodiment of an impact testing device.

FIG. 2 is another isometric view of the impact testing device.

FIG. 3 is a schematic view of an impact test using the impact testing device shown in FIGS. 1-2.

### DETAILED DESCRIPTION

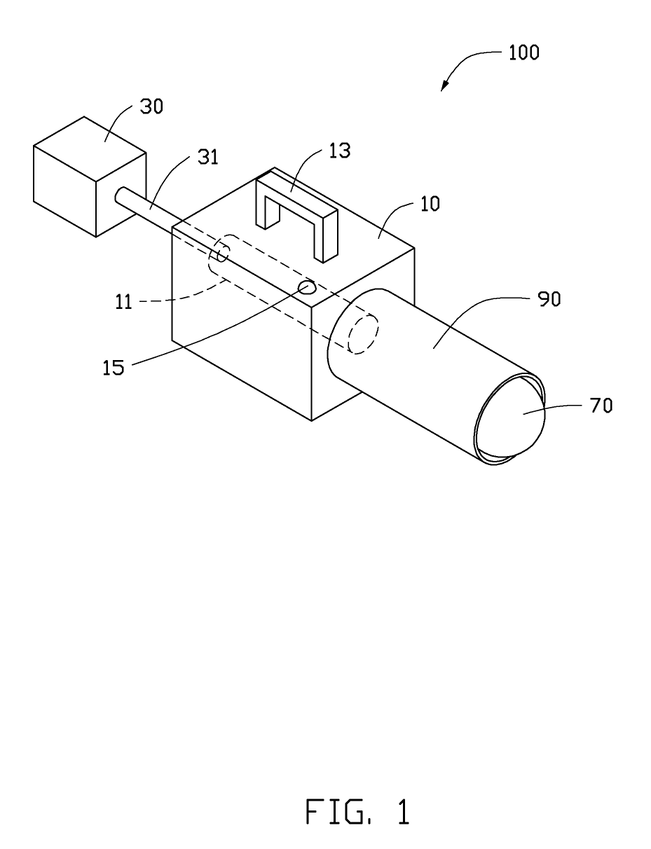

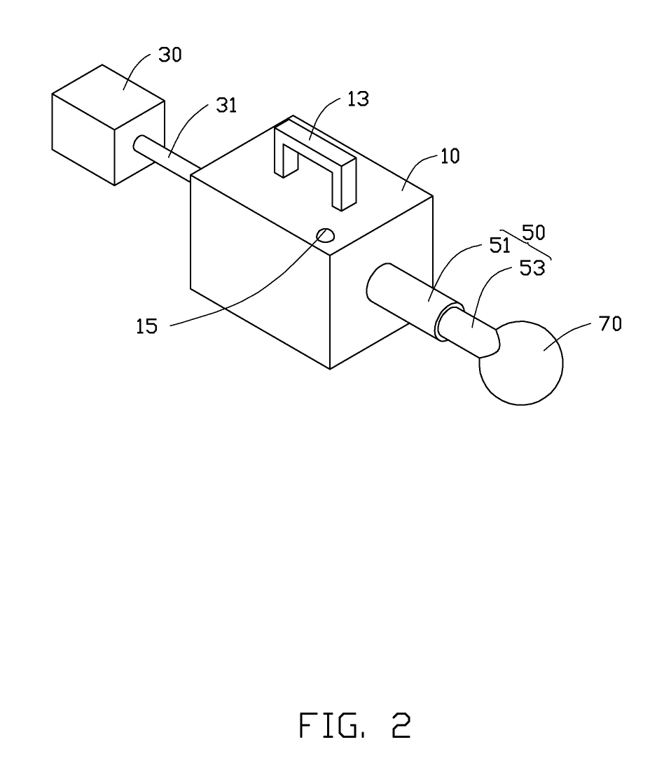

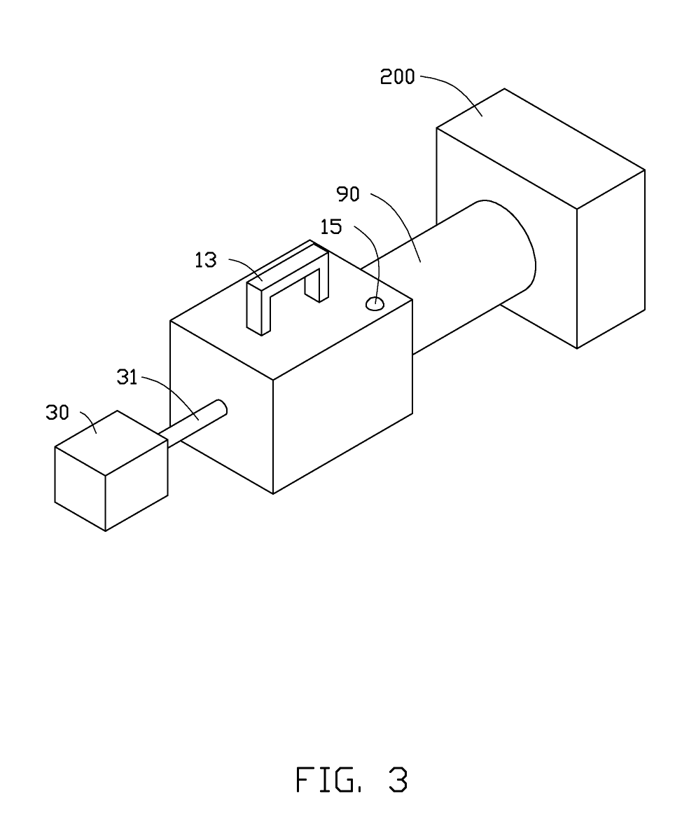

FIGS. 1-3 show an impact testing device 100 according to an exemplary embodiment. The impact testing device 100 is used to test the impact resistance of an electronic device 200. The electronic device 200 may be a mobile phone, a PDA, for example.

The impact testing device 100 includes a main body 10, a pneumatic pump 30, a transmitting element 50, and an impact head 70.

The pneumatic pump 30 and the transmitting element 50 are connected to the opposite two ends of the main body 10 and communicate with the main body 10. The impact head 70 is connected to the free end of the transmitting element 50.

The main body 10 defines a cavity 11 in the main body 10. The cavity 11 is cylindrically-shaped or squarely-shaped, for example. The cavity 11 has two cylindrically-shaped ends, each having an inner diameter matching with the pneumatic pump 30 and the transmitting element 50, which allows the cavity 11 to communicate with the pneumatic pump 30 and the transmitting element 50. In the embodiment, the main body 10 includes a handle 13 for users to hold during test. The main body 10 further includes a switch 15 for users to operate to connect or cut the communication of the cavity 11 and the transmitting element 50.

The pneumatic pump 30 is connected to the cavity 11 by a pneumatic pipe 31. The pneumatic pipe 31 has an inner diameter mating with the end of the cavity 11 connecting to the pneumatic pipe 31. The pneumatic pump 30 may be mounted an adjusting valve (not shown) to adjust the pressure in the cavity 11.

The transmitting element 50 includes a joint pipe 51 and a stretching column 53 slidably mounted in the joint pipe 51. The joint pipe 51 has an inner diameter mating with the end of the cavity 11 connecting to the joint pipe 51, the transmitting element 50 is connected to the main body 10 by the joint pipe 51. The impact head 70 is fastened to the free end of the stretching column 53. In the embodiment, the outer surface of the stretching column 53 and the inner surface of the joint pipe 51 both are smooth surfaces, thus there is almost no friction between the stretching column 53 and the joint pipe 51 during the stretching column 53 moving out of or moving into the joint pipe 51.

The impact head 70 may be made of steel or iron. In the embodiment, the impact head 70 is a sphere having a diameter of about 50 mm and a mass of about 500 g.

In the embodiment, the impact testing device 100 further includes a limiting pipe 90 to limit the testing distance for the electronic device 200. The limiting pipe 90 is located around the transmitting element 50, and half of the impact head 70 when the stretching column 53 completely moves out of the joint pipe 51. In the embodiment, the length of the limiting pipe 90 is larger than the total length of the joint pipe 51 and the impact head 70, and is smaller than or equal to the total length of the impact head 70 and the transmitting element 50 when the stretching column 53 completely stretches out of the joint pipe 51. When the electronic device 200 resists against the end of the limiting pipe 90, the test distance the impact head 70 moves is limited.

When testing the impact resistance of the electronic device 200, the pneumatic pump 30 is first turned on to feed the cavity 11 gas until a desired pressure in the cavity 11 is reached. The desired pressure in the cavity 11 is the pressure that makes the impact head 70 reach a desired speed when the impact head 70 hits the electronic device 200. Then, the electronic device 200 is positioned against a fixing wall (such as a wall of a housing, not shown), and the testing surface of the electronic device 200 is vertically set. The limiting pipe 90 is resisted against the electronic device 200, the center of the impact head 70 aims at the testing point of the electronic device 200. At this time, the switch 15 is turned off and the joint pipe 51 does not communicated to the cavity 11, and the stretching column 53 is completely received in the joint pipe 51. Then, the switch 15 is turned on to make the joint pipe 51 communicate with the cavity 11, thus the stretching column 53 is driven by the pressure of the cavity 11 to move out of the joint pipe 51 and makes the impact head 70 hit the test point at the testing surface of the electronic device 200.

The impact testing device 100 of the exemplary embodiment using an impact head 70, which is pneumatically controlled to test the impact resistance of the electronic devices. Compared to the manual operation of the impact head, the test result using the impact testing device 100 is much more consistent and precise. Furthermore, the impact testing device 100 has a simple structure, and the impact head 70 cannot pop out of the impact testing device 100 to harm testers.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An impact testing device used for testing impact resistance of electronic devices, the impact testing device comprising:
a main body;
a pneumatic pump connecting to one end of the main body and communicating with the main body;
a transmitting element connecting to the other end of the main body and communicating with the main body; and
an impact head fastened on the transmitting element;
the pneumatic pump applying a pressure to the transmitting element to make the impact head move to hit the testing point of the electronic device.

2. The impact testing device as claimed in claim 1, wherein the transmitting element comprises a joint pipe and a stretching column slidably mounted in the joint pipe, the transmitting element is connected to the main body by the joint pipe, the impact head is fastened on the stretching column, the stretching column together with the impact head are driven by the pressure to move to hit the testing point of the electronic device.

3. The impact testing device as claimed in claim 2, wherein before testing, the stretching column is completely received in the joint pipe.

4. The impact testing device as claimed in claim 2, wherein the impact head vertically hits the testing point of the electronic device.

5. The impact testing device as claimed in claim 2, wherein the main body defines a cavity, the pneumatic pump and the joint pipe are connected to opposite ends of the cavity.

6. The impact testing device as claimed in claim 5, wherein the pneumatic pump is connected to the cavity by a pneumatic pipe, the pneumatic pipe has an inner diameter mating with the end of the cavity connected to the pneumatic pipe.

7. The impact testing device as claimed in claim 2, wherein the impact testing device further comprises a limiting pipe connected to the main body and located around the transmitting element, and half of the impact head when the stretching column completely moves out of the joint pipe, the limiting pipe limits the testing distance for the electronic device.

8. The impact testing device as claimed in claim 7, wherein the length of the limiting pipe is larger than the total length of the joint pipe and the impact head, and is smaller than or equal to the total length of the impact head and the transmitting element when the stretching column completely stretches out of the joint pipe.

9. The impact testing device as claimed in claim 2, wherein the main body comprises a switch mounted on the main body, the switch connects or cuts the communication of the cavity and the transmitting element.

10. The impact testing device as claimed in claim 1, wherein the main body comprises a handle formed on the main body for users to hold the main body during a test.

11. The impact testing device as claimed in claim 2, wherein the outer surface of the stretching column and the inner surface of the joint pipe both are smooth surfaces.

12. The impact testing device as claimed in claim 1, wherein the impact head is made of steel or iron.

13. The impact testing device as claimed in claim 12, wherein the impact head is a sphere having a diameter of about 50 mm and a mass of about 500 g.
